(19) United States
(12) Patent Application Publication
(10) Pub. No.: US 2013/0219905 A1
(43) Pub. Date: Aug. 29, 2013

(54) METHOD OF OPTIMIZING THE SPECIFIC FUEL CONSUMPTION OF A TWIN ENGINE HELICOPTER AND TWIN ENGINE ARCHITECTURE WITH CONTROL SYSTEM FOR IMPLEMENTING IT

(71) Applicants: Patrick Marconi, Gelos (FR); Romain Thiriet, Jurancon (FR)

(72) Inventors: Patrick Marconi, Gelos (FR); Romain Thiriet, Jurancon (FR)

(73) Assignee: Turbomeca, Bordes (FR)

(21) Appl. No.: 13/879,829

(22) PCT Filed: Oct. 28, 2011
(86) PCT No.: PCT/FR2011/052532

§ 371 Date: Apr. 17, 2013

(30) Foreign Application Priority Data
Nov. 4, 2010 (FR) 1059065
Mar. 3, 2011 (FR) 1151717

(51) Int. Cl. F02C 5/00

(52) U.S. Cl. CPC F02C 5/00
USPC 60/772; 60/39.12

(57) ABSTRACT

A method and architecture to reduce specific fuel consumption of a twin-engine helicopter without compromising safety conditions regarding minimum amount of power to be supplied, to provide reliable in-flight restarts. The architecture includes two turbine engines each including a gas generator and with a free turbine. Each gas generator includes an active drive mechanism keeping the gas generator rotating with a combustion chamber inactive, and an emergency assistance device including a near-instantaneous firing mechanism and mechanical mechanism for accelerating the gas generator. A control system controls the drive mechanism and emergency assistance devices for the gas generators according to the conditions and phases of flight of the helicopter following a mission profile logged beforehand in a memory of the system.

### TECHNICAL FIELD

The invention relates to a method for optimizing the specific fuel consumption, in short Cs, of a helicopter equipped with two turbo-engines, as well as a twin-engine architecture equipped with a control system for implementing such method.

Generally, at a cruising power, the turbo-engines operate at low power levels, under the maximum continuous power thereof, in short MCP (for Maximum Continuous Power). Such cruising power is equal to about 50% of their maximum take-off power, in short MTOP (for Maximum Take-Off Power). Such low power levels lead to a specific fuel consumption of about 30% higher than the Cs at MTOP, and thus a fuel over-consumption at a cruising power.

A helicopter is provided with two turbo-engines, each being oversized so as to be able to maintain the helicopter in flight in case of a failure in the other engine. At such operation powers dedicated to the management of an inoperative engine, so-called OEI (for One Engine Inoperative) powers, the valid engine provides a power being well beyond its nominal rating so as to allow the helicopter to face up to a dangerous situation, and then to continue its flight. Now, each rating is defined by a power level and a maximum use time. The fuel flow rate being injected into the combustion chamber of the valid turbo-engine is then substantially increased at OEI power to provide such extra power.

### STATE OF THE ART

Such oversized turbo-engines are penalizing in mass and in fuel consumption. To reduce such fuel consumption at a cruising power, it is possible to stop one of the turbo-engines. The operating engine then operates at a higher power level and thus at a more advantageous Cs level. However, this practice goes against the present certification regulations and the turbo-engines are not designed to guarantee a restart reliability rate compatible with the safety standards.

For example, the restart time of the turbo-engine in standby mode is typically of about 30 seconds. Such time can be insufficient according to the flight conditions, for example at low flight height with a partial failure of the engine being initially active. If the standby engine does not restart in time, the landing with the engine in trouble can become critical.

More generally, the use of only one turbo-engine comprises risks in every flight circumstance where it is necessary to have an extra power available requiring in terms of safety to be able to use both turbo-engines.

### DISCLOSURE OF THE INVENTION

The invention aims at reducing Cs so as to tend towards the Cs at MTOP power, while keeping the minimum safety conditions of power to be provided for any type of mission, for example for a mission comprising a search phase at low altitude.

To do so, the invention aims at using a twin-engine system in connection with particular means adapted for guaranteeing reliable restarts.

More precisely, the present invention aims at a method for optimizing the specific fuel consumption of a helicopter equipped with two turbo-engines, each comprising a gas generator provided with a combustion chamber. At least one of the turbo-engines is adapted to operate alone at a so-called continuous stabilized flight speed, the other engine being then at a so-called over-idle nil power speed adapted to switch into an acceleration mode of the gas generator of such engine through a driving being compatible with an emergency restart. Such emergency restart is carried out, in case of a failure of at least a previous conventional restart try, through an emergency mechanical assistance to the gas generator, produced by an autonomous on-board power dedicated to such restart. In case of a failure in the turbo-engine being in operation alone, the other over-idling turbo-engine is restarted by the emergency assistance.

The rotation speed of the gas generator in the over-idling turbo-engine stays substantially lower than the rotation speed of the idling gas generator usually applied to the turbo-engines.

A continuous speed is defined by a non limited time and thus does not relate to the transitory phases of take-off, stationary flight and landing. For example, for shipwrecked people being searched, a continuous speed relates to the cruising flight phase towards the search area and to the low altitude flight phase with the search area above water and to the cruising flight phase for return towards the base.

However, a selective use of the turbo-engines according to the invention, depending on the phases and flight conditions, other than the transitory phases, enables to obtain optimized performances in terms of consumption Cs with powers being close to the MTOP, but lower than or equal to the MCP, while facing up the failure and emergency cases through safe restart means of the turbo-engine at over-idling.

A rating output from an over-idle towards an active rating of the “twin-engine” type is triggered in a so-called “normal” manner. When an in-flight speed change imposes to switch from one to two engines, for example, when the helicopter switches from a cruising speed to a stationary flight, or in a so-called “emergency” manner in the case of an engine failure or in difficult flight conditions.

According to particular embodiments:

the over-idle speed is selected between a rotation keeping speed of the engine with the combustion chamber being ON, a rotation keeping speed of the engine with the combustion chamber being OFF and a nil rotation speed of the engine with the combustion chamber being OFF;

in a “normal” output of the over-idle rating, the chamber being ON, a variation of the fuel flow rate according to a protection law against pumping and thermal runaway drives the gas generator of the turbo-engine into acceleration up to the twin-engine power level, or

the chamber being OFF, an active drive leads the gas generator to rotate according to a pre-positioned speed within an ignition window, in particular according to a speed window of an order of the tenth of the nominal speed, then, once the chamber being ON, the gas generator is accelerated as previously, or

the chamber being OFF, the gas generator is driven by an electrical equipment adapted for such generator, such equipment starts it and accelerates it until its rotation speed is with an ignition window of the chamber, then, once the chamber is ON, the gas generator is again accelerated as previously;

at an over-idling speed within a chamber being OFF, an extra firing of the combustion chamber, i.e. in addition to a conventional firing, can be triggered;

in an emergency output of an over-idle speed with the chamber being OFF, the gas generator being at the rotation speed thereof within the ignition window of the combustion chamber, the chamber is ignited, then the gas generator is accelerated by the emergency assistance device;

the turbo-engines providing unequal maximum powers, the turbo-engine with the lowest power operates alone when the total power required is lower than its MCP, in particular during a low altitude flight rating of the search phase type;

the powers of the turbo-engines present a power heterogeneity ratio at least equal to the ratio between the highest OEI rating power of the turbo-engine with the lowest power and the MTOP power of the most powerful turbo-engine;

the heterogeneity ratio is comprised between 1.2 and 1.5 to cover a set of typical missions; preferably, such ratio is at least equal to the ratio between the highest OEI rating power of the turbo-engine of smaller power and the MTOP power of the most powerful turbo-engine;

a firing with a quasi instantaneous effect complementary to a conventional plug ignition can be triggered to ignite the combustion chamber in an emergency output;

the mechanical assistance energy, in an emergency output of an over-idle speed, is selected amongst energies of hydraulic, pyrotechnical, anaerobic, electrical, mechanical and pneumatic nature;

the emergency assistance is disconnected after the restarting of the valid engine;

the emergency assistance is preferably of an exceptional use, the activation thereof being able to be followed by a maintenance action for the substitution thereof.

According to advantageous embodiments:

two turbo-engines defining MTOP powers on take-off, provide substantially different powers presenting a heterogeneity ratio of powers being at least equal to the ratio between the highest OEI speed power of the turbo-engine of lower power and the MTOP power of the most powerful turbo-engine; one of the turbo-engines being able to operate alone in a continuous speed, the other engine being then in a standby mode with a nil power and the combustion chamber being OFF, while staying kept in rotation by the driving in view of an emergency restart;

both turbo-engines operate together during the transitory phases of take-off, stationary flight and landing; and

the turbo-engine of the lowest power operates alone when the total power being required is lower than or equal to its MCP.

The invention also relates to a twin-engine architecture equipped with a control system for the implementation of such method. Such architecture comprises two turbo-engines each equipped with a gas generator and a free turbine transmitting the available power up to the available maximum powers. Each gas generator is provided with means adapted for activating the gas generator in an over-idle speed output, comprising rotation driving means and acceleration means of the gas generator, firing means with a quasi instantaneous effect, complementary to the conventional plug firing means, and an emergency mechanical assistance device comprising an on-board autonomous energy source. The control system monitors the driving means and the emergency assistance devices of the gas generator depending on the conditions and the flight phases of the helicopter according to a mission profile previously registered in a memory of this system.

Advantageously, the invention can cancel the existence of OEI speeds on the most powerful turbo-engine.

According to preferred embodiments:

the active driving means of a gas generator can be selected between an electrical starter equipping such gas generator, supplied by an on-board mains or a starter/generator equipping the other gas generator, an electrical generator driven by a power transfer box, in short a so-called PTB, or directly by the free turbine of the other turbo-engine, and a mechanical driving device coupled with such PTB or such free turbine;

the complementary firing means can be selected between a glow plug device with laser rays and a pyrotechnical device;

the on-board autonomous source is selected amongst supplying sources of the hydraulic, pyrotechnical, pneumatic, anaerobic combustion, electrical (in particular through a dedicated battery or super-condensers) and mechanical type, including by a mechanical power group connected to the rotor.

### SHORT DESCRIPTION OF THE FIGURES

Other aspects, characteristics and advantages of the invention will appear in the following description, related to particular embodiments, referring to the accompanying drawings wherein, respectively:

FIG. 1 is a diagram representing an exemplary power profile required during a mission comprising a search phase and two cruising phases;

FIG. 2 shows a simplified schema of an exemplary twin-engine architecture according to the invention; and

FIG. 3 shows a command diagram of a control system according to the invention depending on the flight conditions upon a mission having the profile shown on FIG. 1.

### DETAILED DESCRIPTION

The terms “engine” and “turbo-engine” are synonymous in the present specification. In the embodiment being illustrated, the engines have differentiated maximum powers. Such embodiment allows advantageously the OEI speeds to be cancelled on the most powerful turbo-engine, thereby minimizing the mass difference between the two engines. To simplify the language, the most powerful engine or oversized engine also can be designated by the “big” engine and the lowest power engine by the “small” engine.

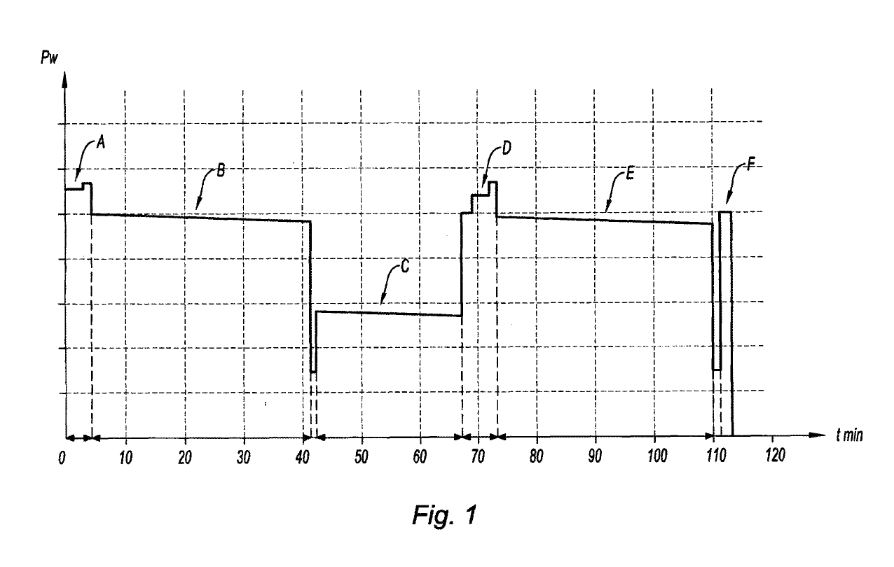

The diagram illustrated on FIG. 1 represents the total power variation Pw being required as a function of time “t” to carry out a mission of recovering shipwrecked people with the help of a twin-engine helicopter. Such mission comprises six main phases:

one take-off phase “A” using the maximum power MTOP;

one cruising flight phase “B” up to the search area carried out at a power level being lower than or equal to the MCP;

one search phase “C” in the search area at low altitude above water, which can be carried out at a power and thus at a flight speed minimizing the hour consumption so as to maximize the exploration time;

one shipwrecked people recovering phase “D” in a stationary flight requiring a power of the other of the power used at take-off;

one return phase to the base “E”, being comparable to the cruising flight out “B” in terms of duration, power and consumption; and

one landing phase “F” requiring a power slightly higher than the power in the cruising phase “B” or “E”.

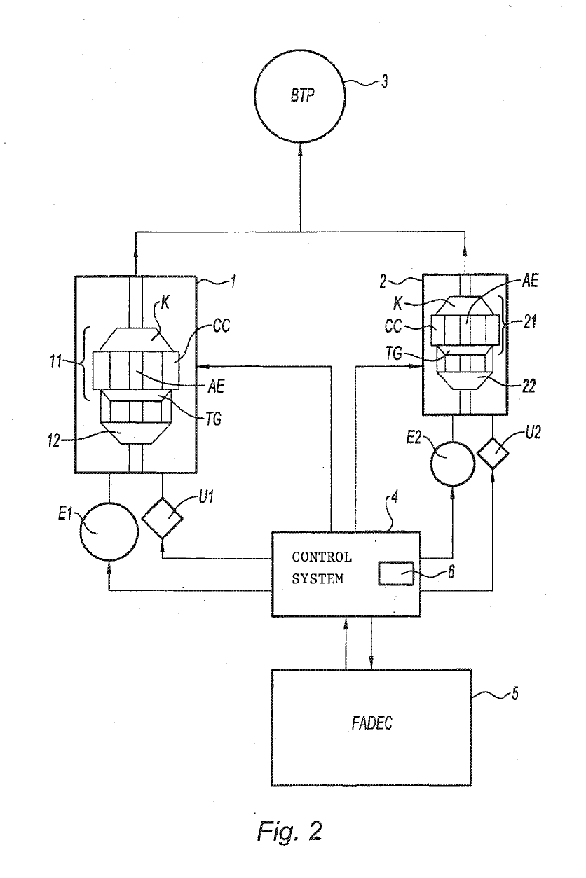

Such a mission covers every phase that can be carried out conventionally during a helicopter flight. FIG. 2 schematically illustrates an exemplary twin-engine architecture of a helicopter enabling to optimize the consumption Cs.

Each turbo-engine 1, 2 comprises conventionally a gas generator 11, 21 and a free turbine 12, 22 supplied by the gas generator to provide power. At take-off and in continuous speed, the power being supplied can reach predetermined maximum values, respectively MTOP and MCP. A gas generator conventionally consists in air compressors “K” in connection with a combustion chamber “CC” for the fuel in the compressed air, which compressors supplying gases providing kinetic energy, and in turbines for a partial expansion of such gases “TG” driving into rotation the compressors via driving shafts “DS”. The gases also drive the free power transmission turbines. In the example, the free turbines 12, 22 transmit the power via a PTB 3 that centralizes the power supplied to the loads and accessories (rotor driving, pumps, alternators, starter/generator device, etc.).

The maximum powers MTOP and MCP of the turbo-engine 1 are substantially higher than the powers the turbo-engine 2 is able to supply: the turbo-engine 1 is oversized in power with respect to the turbo-engine 2. The heterogeneity between the two turbo-engines, corresponding to the ratio between the highest OEI speed power of the turbo-engine 2 and the maximum power MTOP of the turbo-engine 1, is equal to 1.3 in the example. The power of a turbo-engine refers here to the intrinsic power, such turbo-engine can supply at most at a given speed.

Alternatively, both turbo-engines 1 and 2 can be identical and the maximum powers MTOP and MCP of such turbo-engines are then also identical.

Each turbo-engine 1, 2 is coupled with driving means El and E2 and with emergency assistance devices U1 and U2.

Each means E1 and E2 driving into rotation the respective gas generator 11, 21, consists here in a starter respectively supplied by a starter/generator device equipping the other turbo-engine. And each emergency assistance device U1, U2 advantageously comprises, in this example, glow-plugs as a firing device with a quasi instantaneous effect, in addition to the conventional plugs, and a propergol cartridge supplying an additional micro-turbine as an acceleration mechanical means for the gas generators. Such extra firing device can also be used in a normal output for a flight speed change, or in an emergency output in the over-idling speed.

In operation, such driving means E1, E2, the emergency assistance devices U1, U2 and the commands of the turbo-engines 1 and 2 are managed by activation means of a control system 4, under the control of the general digital command device for the motorization known under the acronym FADEC 5 (for “Full Authority Digital Engine Control”).

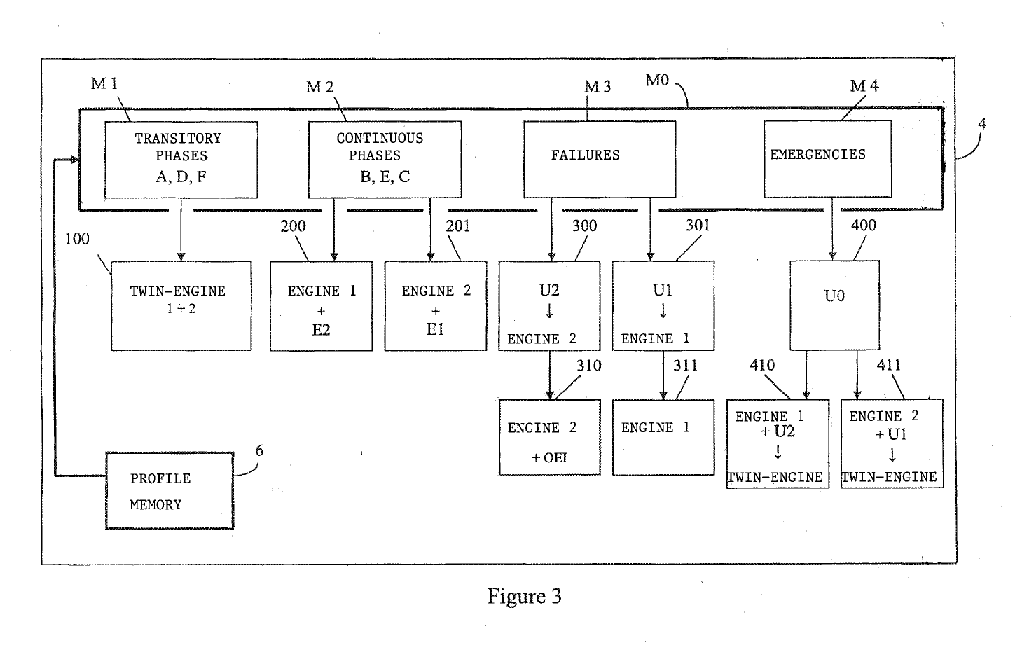

An exemplary management implemented by the control system 4, in the field of a mission profile such as above indicated and registered in a memory 6 amongst others, is illustrated on FIG. 3. The system 4 selects amongst a set of management modes MO the management modes adapted for the mission profile selected in the memory 6, here four management modes for the mission being considered (as a profile illustrated on FIG. 1): one mode M1 relative to the transitory phases, one mode M2 relative to the flights at continuous speed—cruising and search phases—, one mode M3 relative to the engine failures, and one mode M4 for managing the emergency restarts of the engines in an over-idling rating.

Such mission comprises as transitory phases the phases A, D and F, respectively, of take-off, stationary flight and landing. Such phases are managed by the mode M1 of twin-engine conventional operation, in which the turbo-engines 1 and 2 are both operating (step 100), so that the helicopter has a high power available, being able to reach their MTOP. Both engines operate at the same relative level of power with respect to their nominal power. The failure cases of one of the engines are conventionally managed, for example by arming the OEI ratings of the “small” turbo-engine 2 of the lowest power in the case of a failure of the other turbo-engine.

The continuous flight corresponds, in the reference mission, to the phases of cruising flight B and E and to the search phase C at low altitude. Such phases are managed by the mode M2 that provides the operation of one turbo-engine while the other turbo-engine is in an over-idling speed and kept in rotation while the chamber is OFF by driving means, at a firing speed located within its preferential window.

Thus, in the cruising phases B and E, the turbo-engine 1 operates and the other turbo-engine 2 is kept in rotation through its starter being used as driving means E2 and supplied by the starter/generator of the turbo-engine 1. The rotation is adjusted on a preferential ignition speed of the chamber (step 200). Such configuration corresponds to the power need that, in such cruising phases, is lower than the MCP of the “big” engine 1 and higher than the MCP of the “small” engine 2. In parallel, as regards the consumption Cs, this solution is also advantageous, since the big engine 12 operates at a higher relative power level than in a conventional mode, with both engines in operation. When the engines are identical, the power need in such cruising phases cannot exceed the MCP of the engines.

In the search phase C, the “small” turbo-engine 2 of the lowest power operates alone, since it is able to provide the power need itself alone. Indeed, the need is then substantially lower than the MCP power of the oversized turbo-engine 1, but also lower than the MCP of the “small” engine 2. But, mainly, the consumption Cs is lower, since this “small” engine 2 operates at a higher relative power level than the level at which the turbo-engine 2 would have operated. In such phase C, the turbo-engine 1 is kept in an over-idling speed, for example in rotation through the starter used as a driving means E1 at a preferential chamber ignition speed (step 201).

Alternatively, in the case of engines of the same power, only one of both engines operates, the other being kept in an over-idling speed.

Advantageously, the mode M2 also manages the conventional restart of the engine in an over-idling speed when the phases B, E or C are close to come to the end. If this conventional restart fails, the mode switches to the mode M4.

The mode M3 manages the failure cases of the engine used by re-activating the other engine through its emergency assistance device. For example, when the oversized turbo-engine 1, used in operation alone during the phases of cruising flight B or E, fails, the “small” engine 2 is quickly re-activated via its emergency assistance device U2 (step 300). On the same way, if the “small” engine 2 alone in operation during the search phase C fails, the “big” engine 1 is rapidly re-activated via its emergency assistance device U1 (step 301).

Such mode M3 also manages for a long time such cruising or searching phases when the engine initially provided in operation has failed and has been substituted by the other engine being reactivated:

in the case of the cruising phases B and E, the emergency assistance device U2 is disconnected, the OEI ratings of the “small” engine 2 being armed in accordance with the safety certifications (step 310) in case of differentiated engines;

for the search phase C (step 311), the emergency assistance device U1 is disconnected, the MTOP of the oversized engine 1 being at least equal to the power of the highest OEI rating of the “small” engine 2 in the case of differentiated engine.

When the flight conditions become abruptly difficult, a quick restart of the engine in an over-idling speed by activation of the assistance device thereof can be opportune to derive benefit from the power of both turbo-engines. In the example, such device is of a pyrotechnical nature and consists in a propergol cartridge supplying a micro-turbine.

Such cases are managed by the emergency restart mode M4. Thus, whatever it is during the phases of cruising flight B and E (step 410) or during the search phase C (step 411) upon which only one turbo-engine 1 or 2 operates, the operation of the other turbo-engine 2 or 1 is triggered by the activation of the respective pyrotechnical assistance device U2 or U1, only in case of a failure of the conventional restart means U0 (step 400). The flight conditions are then secured by the operation of the helicopter in twin-engine mode.

The present invention is not limited to the examples described and represented. In fact, the invention applies as well to turbo-engines with either differentiated or equal powers.

Moreover, other over-idling speeds than the above mentioned speeds—namely keeping in rotation the engine whatever the chamber is OFF or ON, the rotation speed being advantageously within the ignition window if the chamber is OFF, or a nil rotation speed with the chamber being OFF, the rotation being then advantageously produced by the own starter of the engine supplied by the on-board mains can be defined: in the chamber being ON with a nil rotation speed of the engine, or still with a chamber in an ignition standby or partially ON with a nil or not nil rotation speed of the relative engine.

Furthermore, the control system can provide more or less than four management modes. For example, another mode or an extra management mode may be to take the geographical conditions (mountains, sea, desert, etc.) into account.

It is also possible to add other management modes, for example per flight phase or per structure (engines, driving means, emergency assistance devices) depending on the profiles of the mission.

Furthermore, at least one of the assistance devices can not to be provided for a sole use so as to enable at least another restart through this device upon the same mission.

1-13. (canceled)

14. A method for optimizing specific fuel consumption of a helicopter including two turbo-engines including a gas generator including a combustion chamber, the method comprising:
adapting at least one of the turbo-engines to operate alone at a continuous flight speed, the other engine being then at an over-idling nil power speed adapted to switch into an acceleration mode of the gas generator of such engine through driving means compatible with an emergency restart output;
carrying out the emergency restart, in case of a failure of at least one previous conventional restart try, through an emergency mechanical assistance to the gas generator of the over-idling turbo-engine, produced by an autonomous power and dedicated to the emergency restart; and
in case of a failure in one turbo-engine being operated alone, restarting the other over-idling turbo-engine by the emergency assistance.

15. The optimization method according to claim 14, wherein the over-idling speed is selected between a rotation keeping speed of the engine with the combustion chamber being ON, a rotation keeping speed of the engine with the combustion chamber being OFF, and a nil rotation speed of the engine with the combustion chamber being OFF.

16. The optimization method according to claim 15, wherein, in a normal output of over-idling speed, the chamber being ON, a variation of fuel flow rate according to a protection law against pumping and thermal runaway drives the gas generator of the turbo-engine into an acceleration up to a twin-engine power level.

17. The optimization method according to claim 15, wherein, in a normal output of over-idling speed, the chamber being OFF, driving means leads the gas generator to rotate according to a pre-positioned speed within an ignition window, and then, once the chamber being ON, the gas generator is accelerated up to the twin-engine power level.

18. The optimization method according to claim 15, wherein, in a normal output of over-idling speed, the chamber being OFF, the gas generator is driven by an electrical equipment adapted for the gas generator, the equipment starts the gas generator and accelerates the gas generator until its rotation speed is within an ignition window of the chamber, then, once the chamber is ON, the gas generator is accelerated by a variation of the fuel flow rate up to the twin-engine power level.

19. The optimization method according to claim 15, wherein, in an emergency output of an over-idling speed with the chamber being OFF, the gas generator being at the rotation speed thereof within the ignition window of the combustion chamber, the chamber is ignited, then the gas generator is accelerated by the emergency assistance device.

20. The optimization method according to claim 17, wherein a firing with a quasi instantaneous effect, complementary to a plug conventional ignition, is triggered to ignite the combustion chamber in an emergency output.

21. The optimization method according to claim 14, defining MTOP powers on take-off, wherein the turbo-engines provide different powers presenting a heterogeneity ratio of powers being at least equal to the ratio between a highest OEI speed power of the turbo-engine of lower power and a MTOP power of a most powerful turbo-engine, at least one of the turbo-engines being able to operate alone at a continuous speed, the other engine being then in a standby mode with a nil power and the combustion chamber being OFF, while being kept in rotation by the driving means in view of an emergency restart.

22. The optimization method according to claim 21, wherein both turbo-engines operate together during transitory phases of take-off, stationary flight, and landing.

23. The optimization method according to claim 21, wherein the turbo-engine of a lowest power operates alone when total power being required is lower than or equal to its MCP.

24. A twin-engine architecture comprising:
a control system for implementation of the method according to claim 14,
two turbo-engines, each including a gas generator and a free turbine defining available maximum powers, wherein each gas generator includes driving means adapted for activating the gas generator in an over-idling speed output;
rotation driving means and acceleration means for the gas generator; and
an emergency mechanical assistance device comprising firing means with a quasi instantaneous effect, complementary to plug igniting means, and acceleration mechanical means for the gas generator through an on-board autonomous source; and
wherein the control system monitors the driving means and the emergency assistance devices of the gas generators depending on conditions and flight phases of the helicopter according to a mission profile previously registered in a memory of the system.

25. The twin-engine architecture according to claim 24, wherein the driving means of a gas generator are selected amongst an electrical starter equipping the gas generator, supplied by an on-board mains or a starter/generator equipping the other gas generator, an electrical generator driven by a power transfer box, or directly by the free turbine of the other turbo-engine, and a mechanical driving device coupled with such PTB or with such free turbine.

26. The twin-engine architecture according to claim 24, wherein the driving means is able to keep the gas generator with the combustion chamber being OFF.
